(19) United States
(12) Patent Application Publication
(10) Pub. No.: US 2011/0249595 A1
(43) Pub. Date: Oct. 13, 2011

(54) TECHNIQUE FOR PROVIDING SECURED TUNNELS IN A PUBLIC NETWORK FOR TELECOMMUNICATION SUBSCRIBERS

(75) Inventor: Sharon Rozov, Herzliya (IL)

(73) Assignee: Eci Telecom Ltd, Petach Tikva (IL)

(21) Appl. No.: 13/139,507

(22) PCT Filed: Nov. 25, 2009
(86) PCT No.: PCT/IL2009/001107

§ 371 Date: Jun. 13, 2011

(30) Foreign Application Priority Data
Dec. 11, 2008 (IL) 195884

(51) Int. Cl. G06F 21/00; H04W 88/08; G06F 15/16; H04W 12/00

(52) U.S. Cl. 370/259; 455/410; 726/3

(57) ABSTRACT

A secured OTT architecture for Triple-Play services as well as for OTT based cellular service. Any access networks to which customers of the OTT based services belong, form a so-called last mile access segment which is less prone to security attacks than a public network such as the Internet. The customers' equipment (broadband CPEs, say in the form of modems or Femtocell CPEs) can be freed from securing traffic within the non-public access network, while an access node being a border node between the two networks aggregates the traffic from the access terminals and generates one or more secured communication tunnels via the public network for transmitting the aggregated traffic.

### FIELD OF THE INVENTION

The present invention relates to a technology of providing secured tunnels in a public network such as the Internet. More particularly, the present invention deals with providing security support over the public Internet for various Internet-delivered services. In a specific case, the invention relates to configuring IPsec channels in a public Internet for telecommunication clients to served by femtocells.

### BACKGROUND OF THE INVENTION

Over-The-Top (OTT) service architecture is enabled by the emergence of IP technologies. OTT architecture is an alternative to the traditional architecture where both the service and the network infrastructure are provided by the same carrier. OTT architecture allows Service Providers to access end users and offer them telecommunication services over the last mile facilities of the access network operating carrier and over the Internet. The access network is understood as a broadband network which can be implemented based on technologies such as DSL, PON, WiMax, Broadband Cellular, etc.

Nowadays, OTT based services have become a reality and pose new requirements, including security of telecom traffic traversing the Internet.

Femtocells are small indoor cellular base stations, located in residential homes or in business premises. Femtocells expand indoor cellular coverage while avoiding investments in expensive macro cells. Femtocells services are typically provided using OTT architecture: they connect back to their corresponding mobile operator's network via the user's broadband connection and the public Internet.

Legacy cellular services are usually secured and a similar security level is required from Femtocell implementations. Since the public Internet is a-priori an open network, the connectivity of cellular subscribers through the public open Internet creates a security concern.

Some prior art references try dealing with problems of secure transmission of cellular communication sessions via various communication networks.

WO08019970-A (to Nokia Siemens Networks) concerns a method for handover of a WLAN connection or a cellular mobile network connection between a Home Agent (HA) and a mobile station (UE) to a WLAN connection between a Home Agent (HA) and the mobile station (UE), wherein an IPSec Tunnel between the mobile station (UE) and a Packet Data Gateway (PDG) is serially connected to a Mobile Internet Protocol tunnel between the Packet Data Gateway (PDG) and the Home Agent (HA). The mentioned solution discusses how to perform handover during the period of time when the secure line is already established in a wireless LAN. Neither a problem nor a method of establishing a secure traffic path via a public network is discussed.

US2008115203-A describes a technique for traffic engineering in secured networks. A node in a network may be authenticated as a trusted third party and that trusted third party may be enabled to acquire security information shared between or among a plurality of network entities. In this manner, the trusted third party may parse, access and operate on IPSec encrypted traffic communicated between or among the plurality of network entities. Shared security information may comprise one or more session keys utilized for encrypting and/or decrypting the IPSec secured traffic. The node may parse IPSec traffic and identify a flow associated with the IPsec traffic. In this manner, the node may generate and/or communicate statistics pertaining to said IPSec secured traffic based on the flow with which the traffic is associated. The above solution discusses transmission of cellular services via private mobile networks. No consideration is devoted to a possibility of using any public (unsecured) core network for transmitting the cellular traffic.

FIG. 1 illustrates one known configuration being an attempt to provide secured cellular services via the public Internet (12). Its full description will be provided in the Detailed Description of the invention. Femtocells (20, 22, 24) are small indoor wireless base stations, located in residential homes or in business premises. Femtocells expand indoor wireless coverage and enable cellular operators to enhance their service portfolio by offering fixed line broadband services. FIG. 1 shows a practical case where femtocells connect back to their mobile operator's network (26) via the users' broadband connection (21, 23, 25) and the public Internet (12)

Since connectivity through the public Internet creates a security problem, each femtocell, using its CPE (Customer Premises Equipment), establishes an encrypted tunnel (31, 33, 35) using a standard IPSec technology (secured tunnels over IP networks). These IPSec tunnels terminate in the operator's network, at a Security Gateway(30) or a Concentrator (Aggregator).

With millions of femtocells deployed in a network, mobile operators will require large scale Security Gateways at the edge of their core/transport networks to handle millions of femtocell-originated IPSec tunnels. The need for IPSec support also adds to the femtocell's CPE cost, while a low cost CPEs is key to the success of femtocells.

Coming back to OTT based services, it should also be mentioned that the technology for transmitting OTT based services as video, voice and data (so-called triple-play services) via the public Internet exists, however security measures are not implemented for these services.

IPSec scalability introduces manageability issues and at the same time it is reflected in added cost, both at the network's core and at the CPEs.
To the best of the Applicant's knowledge, no solutions for minimizing the number of IPsec tunnels have been proposed by now.

### OBJECT AND SUMMARY OF THE INVENTION

It is therefore one object of the present invention—to propose a new, secured OTT architecture for so-called Triple-Play services (voice, data, video).

Another object of the invention is to propose an efficient technique for a new, secured OTT based cellular service.

Both of the above-mentioned objects and some other ones can be achieved by using the following Inventor's idea.

The Inventor has recognized that any access networks (be they fixed broadband ones, wireless or cellular ones) to which customers of the OTT based services belong, form the so-called last mile access segment which is less prone to security attacks than a public network such as the Internet. Therefore, the Inventor has made a conclusion that the customers' equipment (broadband CPEs, say in the form of modems or Femtocell CPEs) can be freed from the problem/attempts of securing the transmission within the non-public access network.

The solution proposed by the Inventor is:

the function of generating secured transmission tunnels for the OTT clients residing in non-public access networks may be transferred from the customers' equipment to an access node being a border node between the non-public access network and the public network,

the border node can be adapted to aggregate traffic carried by telecommunication sessions established between one or more terminals and the OTT based service Operator; to generate one or more secured transmission tunnels via the public network and to transmit the aggregated traffic via the public network through these tunnels, wherein each of such tunnels usually serves a number of telecommunication sessions of more than one terminals. Usually, during periods of typical service demand, the number (let it be marked M) of such secured tunnels will be much smaller than the number (N) of OTT telecommunication sessions and even smaller than the number (C) of OTT served terminals. However, during low service demand periods the number M of established secured tunnels via the Internet may be even equal to the number of communication sessions N (say, when M=N=0, M=N=1, etc.).

In practice, at high service demand periods M<<N (at least by one order of magnitude), and M<<C.
Actually, a number M of secured tunnels via the public network can be estimated as follows: to M≧K*Q, where

K reflects a number of PNSPs (Public Network Service Providers) serving OTT clients in the access network of interest, and

Q reflects a number of various OTT Operators' networks serving OTT clients in the access network of interest.

It should be kept in mind that any of the secured tunnels via the public network may be adapted to serve one or more communication sessions of the same PNSP and the same OTT Operator's network. OTT-based service of another OTT Operator's Network, if ordered by the subscribers of the access network, will require establishing a separate secured tunnel via the public network.
The Inventor's idea actually brings a new principle of secured transmission of OTT-based services, which results in a number of achievements, namely:
a) a new, secured OTT technique for so-called Triple-Play services (voice, data, video);
b) an efficient technique for a secured OTT based cellular service;
c) for any of the above techniques, reducing the number of required secured tunnels via a public transport network, and simultaneously allowing to keep to minimum the cost of customers' premises equipment and to reduce volume of Gateways of OTT Operators' networks.
The general method can be then formulated as follows:

A method of providing secured communication tunnels via a public network (such as the Internet) for access terminals situated in a non-public access network, and subscribed to OTT based telecommunication services, wherein these services are provided by an OTT service Operator network via the public network and via an, access node being a border node between the public network and the non-public access network; the method comprises:

establishing communication between said access terminals and the border node, to carry traffic of communication sessions of the access terminals, the traffic being related to the OTT based telecommunication services;

at the border node:

aggregating said traffic from the access terminals,

generating one or more, preferably bidirectional, secured communication tunnels via the public network between the border node and the OTT service Operator network, and

transmitting said aggregated traffic via the public network through said secured tunnels, wherein each of said secured tunnels is adapted to serve communication sessions generated by more than one of the access terminals.

The access terminals (sometimes named “subscribers” in the description) should be understood as subscribers' equipment such as CPE (Customer Premises Equipment), moderns, femtocells etc., which may further be connected to end points such as telephones, mobile phones, computers, faxes which may be in use of different individuals.

In the non-public access network, the mentioned access terminals may form a group of access terminals which are subscribed to secured OTT-based telecommunication services. In other words, communication sessions of these access terminals should preferably be transmitted in a secured manner. Actually, other access terminals may exist in the access network, which are subscribed to OTT-based services but not subscribed to secured transmission thereof.

The procedure of generation of a secured tunnel via a public network for data to be secured may be understood as comprising a “set up” process for establishing a communication path, accompanied with exchange of specific encryption keys to be utilized when encapsulating/de-encapsulating the data respectively into/from the public network packets.

In the present description, the term OTT based service Operator may intermittently be used with the terms OTT service operator, OTT service provider, OTT operator and OTT provider.

In one of the best versions of the presently proposed inventive method, the public network may be the public Internet, and the secured communication tunnels via the public networks may be IPSec tunnels.

The access network may be any broadband access network (fixed, wireless, cellular or any combination thereof).

Preferably, the communication established between said access terminals and the access (border) node, may be performed via non-secured communication channels.

For performing communication in both directions, the method may further comprise:

recognizing traffic arriving to the border node in communication sessions from the public network via any of said one or more secured tunnels as communication sessions related to OTT-based services and intended for said access terminals of the access network;

for each of the communication sessions recognized as intended for said access terminals of the access network, identifying an intended access terminal among a plurality of the access terminals in the access network, and forwarding said recognized communication sessions to respective identified intended access terminals.

Based on the above-defined general solution, the first object of the invention (i.e., creating a novel, secured OTT architecture for triple-play services) can be achieved, for example, if some or all of the access terminals of the non-public access network are wireline broadband CPEs (for example, DSL modems), and if the OTT operator's network is a fixed-lineTriple-Play service provider's network.

The second object of the invention (i.e., creating a novel effective OTT architecture for cellular services) can be achieved, for example, if some or all of the access terminals of the non-public access network are femtocell access terminals, each implemented as a ferntocell CPE (Customer Premises Equipment), wherein the OTT operator's network is a Mobile or Femtocell operator's network.

According to a second aspect of the invention, there is provided an access node (such as DSLAM—Digital Signal Line Access Multiplexer or MSAN—Multiservices Access Node), for operating as a border node between a non-public access network and a public network conveying OTT—based services to access terminals. Such a border node should be provided with:

means for aggregating traffic of communication sessions established between the border node and the access terminals of the access network, wherein said communication sessions being related to the OTT-based services,

a novel, hardware and/or software unit for
generating one or more secured tunnels via the public network between the border node and the OTT operator's network, for serving by each of said secured tunnels communication sessions of more than one access terminals;
transmitting the aggregated traffic via said one or more secured tunnels.

The access node may preferably be capable of generating said secured tunnels as bidirectional.

The hardware and/or software may be further adapted for recognizing, among all communication sessions established between the border node and the access terminals of the access network, communication sessions related to OTT-based services and intended for secured transmission via the public network (i.e., the terminals are subscribed to the secured service);

transmitting via said one or more secured tunnels only traffic of said recognized communication sessions.

The access node (or its hardware/software unit) may be further adapted to perform the following operations with respect to traffic arriving from the public network:

recognizing traffic arriving to the border node from the public network in communication sessions established via any of said one or more secured tunnels as communication sessions related to OTT-based services and intended for said access terminals of the access network;

identifying, for each of the recognized communication sessions, its intended access terminal, and

forwarding traffic of the recognized communication sessions to respective identified intended access terminals.

To perform the above functions, the hardware/software unit of the border node should be adapted to keep docketing (maintain binding) between the communication sessions related to the OTT-based services, the subscribers and the generated secured tunnels, for proper routing of the traffic in both directions. This can be implemented, for example, by forming suitable routing tables in said novel unit of the border node.

The proposed access border node (e.g., DSLAM) will aggregate the OTT-based traffic from the access terminals into the mentioned one or more secured bidirectional tunnels (for example, IPSec tunnels) which will safely traverse the public network (Internet) and reach the OTT operator's network; the secured tunnels may terminate, for example, at the operator's Security Gateway.

The border/access node (such as DSLAM) is preferably adapted to aggregate all OTT-related traffic generated by any OTT-served access terminals connected to that border node; these access terminals are considered to belong to one and the same common access network.

In the same time, there may be several (two or More) OTT providers serving the access network, providing a range of OTT based services (different or even the same but competing services). However, the above-mentioned secured communication tunnels (M) via the public network are generated/dedicated to one OTT operator's network. Therefore, another OTT operator's network will be associated with a different set (say, M1) of secured tunnels generated by the border node.

According to a third aspect of the invention, there is also provided a software product comprising computer implementable instructions and/or data for carrying out the described method, stored on an appropriate computer readable storage medium so that the software is capable of enabling operations of said method when used in the described border node.

According to yet a further aspect of the invention, there is further provided a network system comprising the public network (such as the Internet), a non-public broadband access network with a number of OTT service access terminals respectively served by CPEs, one or more OTT service provider (service operator) networks and the described border node, the border node ensuring communication between the public Internet network and the non-public broadband access network; the network system being capable of providing secured transmission of OTT-based services to said OTT service access terminals through secured tunnels (such as IPSec tunnels) so that each tunnel via the public network is capable of serving a number of communication sessions established between two or more of said OTT service access terminals and one of the OTT service provider networks.

Various OTT network architectures of the above system may exist: a secured triple-play service OTT architecture and a novel secured femtocell service OTT architecture, any combination of them, etc.

The network system may comprise more than one different OTT provider networks, for each of them a separate set of the secured tunnels should be generated.

The proposed solution is non-obvious at least owing to the following reasons.

Presently, the provider of OTT based services, for providing security to the traffic, has to support a huge number of individual IPSec tunnels from the OTT provider's network up to the individual OTT service subscribers located in an access network. This challenges the scalability of the OTT provider's Security Gateway, both in terms of overload handling, and management of large numbers of tunnels. Moreover, to create the mentioned huge number of individual IPSec tunnels, the subscriber's CPE must house high complexity (and therefore, cost) to support and process an individual security tunnel.

At the same time, an access node (such as DSLAM) is located in any typical broadband access network.

The idea to provide the border access node with novel functions so as to allow solving the problem of OTT service providers and effectively ensure traffic security therefore seems highly non-expected and non-obvious.

### BRIEF DESCRIPTION OF THE DRAWINGS

The invention will further be described and illustrated with the aid of the following non-limiting drawings, in which:

FIG. 1 (prior art) schematically illustrates how secured tunnels are usually arranged in communication networks supporting OTT based services (using a specific example of IPsec tunnels generated at Femtocell Customer Premises Equipment units).

FIG. 2 schematically illustrates the proposed inventive method/system on a specific example of IPSec tunnels generated at a border access node such as DSLAM for femtocell-served OTT subscribers.

FIG. 3 schematically illustrates another example of the proposed inventive method/system, where aggregated secured tunnels via a transport public network are generated at a border access node for another type of OTT based services.

### DETAILED DESCRIPTION OF THE PREFERRED EMBODIMENTS

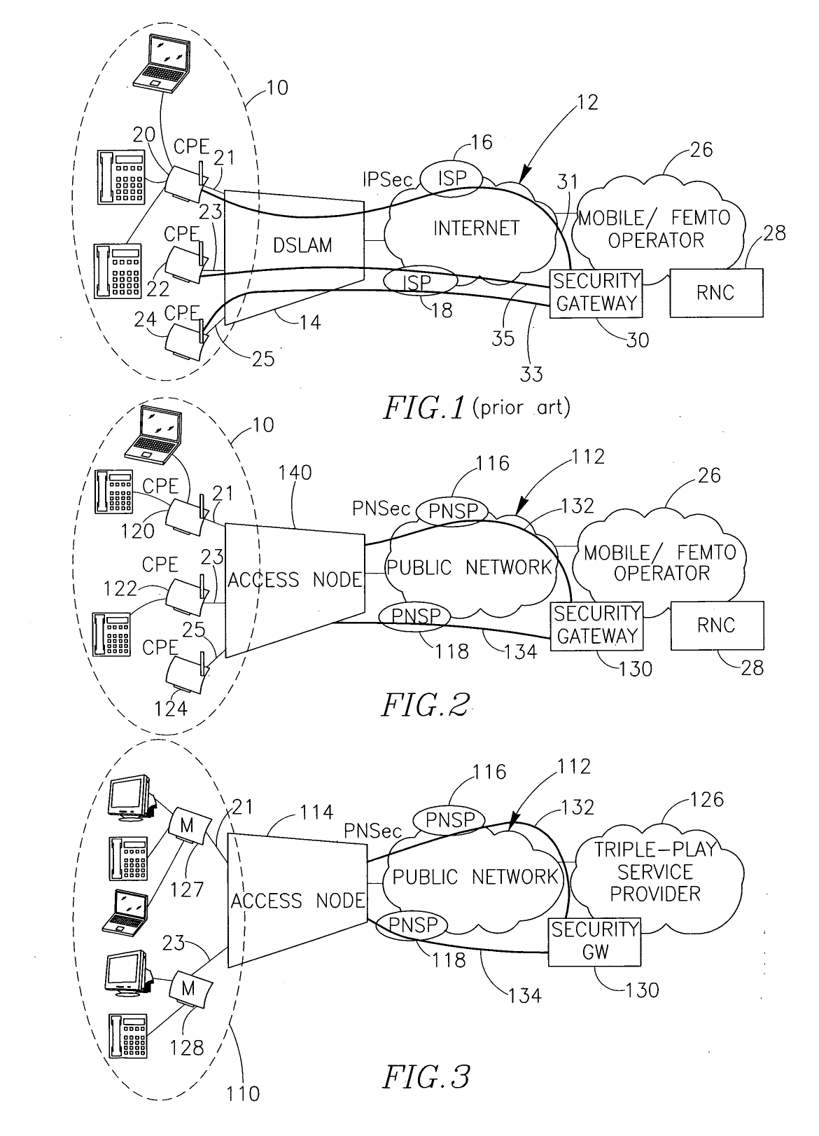

FIG. 1 (prior art) was briefly described in the Background of the invention. It illustrates a non-public access network 10 inter-communicating with a public Internet network 12 via a border access node (here, DSLAM) 14. It should be kept in mind that other functional blocks (for example, BRAS) may be placed between the access node and the Internet. Access to the public Internet network 12 is ensured by a number of Internet service providers ISP (two of them are shown and marked with reference numerals 16 and 18). In the figure, the access network 10 comprises a number of small indoor wireless base stations to (say, three such femtocell CPEs located in three business or private premises of OTT clients). The femtocells are actually CPE units 20, 22, 24 that provide wireless coverage and allow interconnecting the OTT clients, via fixed broadband lines 21, 23, 25, and further via the Internet 12 to a cellular operator which is illustrated as a mobile/femto Operator network 26 connected to the is Internet 12. The services provided by the mobile/femto operator network 26 constitute one example (type) of OTT based services.
As shown in FIG. 1, the Mobile/femto Operator network 26 is provided with a Radio Network Controller RNC 28 and a Security Gateway 30 intended for receiving and transmitting traffic via secured tunnels (IPSec) 31, 33, 35 established between the Operator network 26 and the respective OTT clients (access terminals, femtocells, CPEs) 20, 22, 24.
According to the conventional technique, each individual IPSec tunnel 31 (33, 35) is established when a suitable access terminal 20 (22, 24), being provided with a femtocell CPE capable of supporting IPsec tunnels, initiates a communication session with the border access node (DSLAM) 14. Each conventional individual IPsec tunnel 31 (33, 35) is established per access terminal, originates from its CPE 20 (22, 24), transparently passes the DSLAM 14, then traverses the public Internet 12 through one of the ISPs and terminates at the Security Gateway 30. Each of the IPSec tunnels is used in both directions.
FIG. 2 schematically illustrates one exemplary version of the proposed technique for establishing secured tunnels for OTT clients situated in a non-public access network. The technology is described and explained using the above example of a number of femtocell subscribers located in a broadband access network 10, which are interconnected with the Femto operator network 26 via a public network 112 (for example, the Internet).
Elements similar to those in FIG. 1 are marked with similar two-digit reference numerals. Elements different from those in FIG. 2 are marked with three-digit reference numerals. It should be noted that more than one OTT provider network (femto/mobile or another, not shown) may provide services to the access network 10 clients.
The CPE units 120, 122, 124 (access terminals) of the OTT femto subscribers are connected to end users such as telephones, computers, etc. like in FIG. 1, is but they are much simpler than 20, 22, 24 of FIG. 1, since they do not have to provide the expensive functionality of generating secured tunnels. When establishing communication sessions to a modified border node 140 via the fixed broadband lines 21, 23, 25, the CPE units 120, 122, 124 (access terminals) utilize usual non-secured communication channels in the access network. However, the modified Access Node 140 (for example, enhanced DSLAM or MSAN) is adapted to recognize communication sessions initiated by the 120, 122, 124 as sessions to be secured. (Let us suppose that these access terminals are subscribed to secured transmission via the public network 112).
DSLAM 140, when receiving traffic from any of the femtocells/CPEs 120, 122, 124, establishes M secured tunnels via the public network (Public Network secured tunnels PNSec 132, 134) and performs so-called “aggregation” of traffic, but in our case—for secured transmission thereof. Say, the aggregated traffic of N communication sessions simultaneously taking place from C femtocell access terminals is transmitted via M secured tunnels in the public network (in optimal load conditions, M<C, but preferably M<<C and M<<N since it is understood that one access terminal may initiate more than one communication session at a time, and that a great number of access terminals may hold communication sessions simultaneously).
The number M is at least a number K of Public Network Service Providers PNSPs (116, 118) in use for the public network, multiplied by a number Q of OTT providers M≧K*Q.
To transmit traffic of a communication session via a secured tunnel (PNSec) in the public network, the Access Node 140, for example, may check the following for selecting one of the M secured tunnels for that communication session:
to which OTT provider's network (mobile/femto operator 26 or any additional one) the specific communication session applies, which PNSP (116, 118) is selected by that specific subscriber. To generate a new secured tunnel, a regular set up procedure and the exchange of encryption keys should take place between the Access Node 140 and the Security Gateway 130 (in contrast with FIG. 1, where all that must be performed between a specific CPE and the Security Gateway 30). In practice, according to FIG. 2, a huge number (millions) of simultaneous communication sessions originating from millions of femtocells served by a number of mobile operators will be aggregated into quite a moderate number of secured tunnels via the public network.
The Access Node 140 should also be provided with a suitable hardware/software means for docketing (binding) the incoming N communication sessions from OTT access terminals and the M aggregated PNSec tunnels, so as to perform distribution of traffic in the opposite direction. Namely, based on the docketing information stored in the Access Node 140, the traffic incoming the Access Node from the side of Internet network 12 via the M secured tunnels, will be related to N suitable communication sessions initiated by specific OTT access terminals.
The function of a Security Gateway 130 of FIG. 2 is quite standard, it just must obtain secured traffic of different communication sessions of different access terminals from a specific PNSec tunnel, and send suitable traffic in the opposite direction via the same PNSec tunnel. Gateway 130 does not have to perform any novel docketing or routing for performing that function.
In the network architecture illustrated in FIG. 2, the public network is preferably the public Internet, the non-public access network is a broadband access network, the OTT provider's network is a Femto Operator network, the OTT telecommunication subscribers are presented by Femtocell CPEs, and the to Access Node is a DSLAM (Digital Signal Line Access Multiplexer) between the public Internet network and the non-public access network; the DSLAM is capable of establishing a limited number of secured IPsec tunnels via the public Internet network for serving a much greater number of OTT communication sessions initiated by the mentioned access terminals, so that one IPsec tunnel via the public Internet network usually serves multiple communication sessions established between two or more Femtocell CPEs and the Femto (Mobile) provider's network Security Gateway.
FIG. 3 illustrates another example of the proposed new security solution for OTT based architecture and for a different type of OTT based services. A non-public access network 110 comprises a number of access terminals of Triple—Play services (video, voice and data). These access terminals are broadband modems 127, 128 (e.g., DSL modems) connected at one end to terminals such as a computer, a TV set, an IP phone and at another end to a modified Access Node 114. OTT based services to the access terminals 127, 128 are provided via a public network (say, the public Internet) 112 by a network 126 of a Triple-Play service provider.
The Access Node (DSLAM or MSAN) 114 is capable of aggregating various (video, voice, data, etc.) communication sessions initiated by the access terminals 127, 128 (and applied to 114 without security, via the broadband lines 21, 23) into a reduced number of secured tunnels established via the public network 112 (Public Network secured tunnels PNSec 132, 134). The tunnels 132, 134 (for example, IPSec tunnels), are established preliminarily by the Access Node 114 using two service providers PNSPs 116 and 118 which are in use by one or another of the subscribers in the access network 110 (or any other access network—not shown—if connected to the Access Node and utilizing OTT based services).
The secured tunnels 132, 134 terminate at a Security Gateway 130 of the network 126. By now, neither such secured tunnels, nor the Access Node capable of generating thereof for OTT based triple-play services, nor the Secure Gateway for a Triple-Play service provider network has been proposed. In the network architecture illustrated in FIG. 3, the public network is the public Internet network, the non-public access network is a broadband network, the OTT provider's network is a Triple-play operator's (service provider's) network, the OTT telecommunication access terminals are broadband subscribers' CPEs (for example, DSL broadband modems), and the Access Node is a DSLAM (Digital Signal Line Access Multiplexer) that ensures intercommunication between the public Internet network and the non-public access network. The DSLAM is provided with a novel functionality to establish a limited number of secured IPsec tunnels via the public Internet network for serving a much greater number of OTT communication sessions initiated by the access terminals, so that one IPsec tunnel via the public Internet network serves multiple communication sessions established between two or more broadband CPEs and the Triple-play operator's network Gateway.

By now, nobody has suggested conveying OTT-based triple-play services via secured tunnels in a public network. Naturally, nobody has proposed aggregating traffic in such secured tunnels. The proposed technology solves both the problem of security of triple-play OTT service transmitted via the public network such as the Internet, and the problem of minimizing secured traffic flows via public networks, and is therefore novel and non-obvious:

It should be appreciated that not only the illustrated embodiments are possible; other systems for OTT services can be proposed for implementing the general concept and should be considered part of the invention, wherein the general scope of the invention is defined by the claims that follow.

1-20. (canceled)

21. A method of providing secured communication tunnels via a public network for access terminals situated in a non-public access network and subscribed to OTT based telecommunication services, wherein said OTT based services are provided by an OTT service operator's network via the public network and via an access node being a border node between the public network and the non-public access network; the method comprises:
establishing communication between said access terminals and the border node, to carry traffic of communication sessions of the access terminals, related to the OTT based telecommunication services;
at the border node, aggregating said traffic from the access terminals,
at the border node, generating one or more secured communication tunnels via the public network between the border node and the OTT service operator's network, wherein each of said secured tunnels is capable of serving communication sessions generated by two or more access terminals, and
transmitting the aggregated traffic via the public network through said one or more secured tunnels.

22. The method according to claim 21, wherein the public network is the public Internet.

23. The method according to claim 21, wherein the secured communication tunnels via the public network are IPSec tunnels.

24. The method according to claim 21, wherein the secured communication tunnels are bidirectional.

25. The method according to claim 21, wherein said access terminals form, in the non-public access network, a group of access terminals subscribed to secured OTT-based telecommunication services.

26. The method according to claim 21, further comprising:
recognizing traffic arriving to the border node in communication sessions from the public network via any of said one or more secured tunnels as communication sessions related to OTT-based services and intended for said access terminals of the access network;
for each of the communication sessions recognized as intended for said access terminals of the access network, identifying an intended access terminal, and forwarding said recognized communication sessions to respective identified intended access terminals.

27. The method according to claim 21, wherein some or all of the access terminals of the non-public access network are Customer Premises Equipment units CPEs, and wherein the OTT service operator's network is a Triple-Play service provider's network.

28. The method according to claim 21, wherein some or all of the access terminals of the non-public access network are femtocell access terminals in the form of femtocell Customer Premises Equipment units CPEs, and wherein the OTT service operator's network is a Mobile or Femto operator's network.

29. An access node for operating as a border node between a non-public access network and a public network conveying OTT-based services to access terminals of the access network from an OTT operator's network, the border node being provided with:
means for aggregating traffic of communication sessions established between the border node and the access terminals of the access network, wherein said communication sessions being related to the OTT-based services,
a hardware and/or software unit for
generating one or more secured communication tunnels via the public network between the border node and the OTT operator's network, wherein each of said secured tunnels is adapted to serve communication sessions of more than one of the access terminals;
transmitting the aggregated traffic via said one or more secured tunnels.

30. A software product comprising computer implementable instructions and/or data for carrying out the method according to claim 21, stored on an appropriate computer readable non-transitory storage medium so that the software is capable of enabling operations of said method when used in an access node.

31. A network system comprising a public network, a non-public broadband access network with a number of OTT service access terminals, one or more OTT service operator's networks and an access node according to claim 29, the access node ensuring communication between the public network and the non-public broadband access network; the network system being capable of securely providing OTT-based services to said OTT service access terminals through secured tunnels via the public network, so that each secured tunnel is adapted to serve communication sessions established between two or more of said OTT service access terminals and one of the OTT operator's networks.

32. The network system according to claim 31, wherein at least some of the OTT service access terminals are Femtocell access terminals in the form of Femtocell Customers Premises Equipment units CPEs, one of said OTT service Operator's networks is a Femto Operator network, and the access node is a Digital Signal Line Access Multiplexer DSLAM or a Multiservice Access Node MSAN enabling communication between the public network being the Internet and the non-public broadband access network.

33. The network system according tot claim 31, wherein at least some of the OTT service access terminals are triple-service access terminals implemented as broadband Customers Premises Equipment units CPEs, one of the OTT service Operator's network is a Triple-service provider network, and the access node is a Digital Signal Line Access Multiplexer DSLAM or a Multiservice Access Node MSAN enabling communication between the public network being the Internet and the non-public broadband access network.

34. The network system according to claim 31, comprising more than one different OTT service operator's networks, the network system being configured to provide secured transmission of OTT-based services to said OTT service access terminals from said different OTT service operator's networks by respective different sets of the secured tunnels via the public network.
